(19) United States
(12) Patent Application Publication
(10) Pub. No.: US 2009/0322696 A1
(43) Pub. Date: Dec. 31, 2009

(54) METHOD FOR ASSEMBLING A DIGITIZER SENSOR

(75) Inventors: Merav YAAKOBY, Kfar-Saba (IL); Doron Teomim, Mediln (IL); Dov Nachshon, Rosh HaAyin (IL); Dov Brecher, Givat Shmuel (IL); Alex Kaimonovich, Holon (IL)

Correspondence Address: MARTIN D. MOYNIHAN d/b/a PRTSI, INC., P.O. BOX 16446, ARLINGTON, VA, 22215, US

(73) Assignee: N-trig Ltd., Kfar-Saba (IL)

(21) Appl. No.: 12/486,787

(22) Filed: Jun. 18, 2009

Related U.S. Application Data
(60) Provisional application No. 61/129,308, filed on Jun. 18, 2008.

(51) Int. Cl. G06F 3/041; B32B 37/02

(52) U.S. Cl. 345/173; 156/60; 178/18.03

(57) ABSTRACT

A digitizer assembly includes a transparent sensor patterned with conductive elements within at least one layer, a PCB or the like patterned with conductive elements positioned along at least one edge of the transparent sensor, wherein the conductive elements at least partially match the conductive elements on the transparent sensor, and a double sided adhesive positioned between the transparent sensor and the PCB operative to mount the PCB on to the transparent sensor.

### RELATED APPLICATION

The present application claims the benefit under section 35 U.S.C. §119(e) of U.S. Provisional Patent Application No. 61/129,308 filed on Jun. 18, 2008, which is incorporated herein by reference in its entirety.

### FIELD OF THE INVENTION

The present invention, in some embodiments thereof, relates to assembly of digitizer sensors and, more particularly, but not exclusively, to methods for establishing electrical connection between conductive elements on the sensor and electrical components associated with the sensor.

### BACKGROUND OF THE INVENTION

Digitizing systems that allow a user to operate a computing device with a stylus and/or finger are known. Typically, a digitizer is integrated with a display screen, e.g. over-laid on the display screen, to correlate user input, e.g. stylus interaction and/or finger touch on the screen with the virtual information portrayed on display screen.

Typically, the digitizer systems include a digitizer sensor formed from a transparent substrate(s), e.g. PolyEthylene Terephthalate (PET) foils or glass, patterned with conductive material. During operation of the digitizer system, signals are transmitted through the conductive material and outputs from the conductive material are detected. Based on the outputs detected, user interaction, e.g. stylus and finger touch on the screen is identified and/or located.

Electrical components and/or circuitry associated with the digitizer, e.g. to provide signal transmission and detection are typically arranged on a printed circuit board (PCB) and are electrically connected to the conductive lines patterned on the digitizer sensor. In some known digitizer system, the PCB includes a set of conductive pads matching a pattern of conductive pads formed at or near edges of conductive lines of the digitizer sensor and electrical connection is provided by mounting the PCB directly on the edges of the conductive lines of the digitizer sensor.

U.S. Pat. No. 6,690,156 entitled “Physical Object Location Apparatus and Method and a Platform using the same” and U.S. Pat. No. 7,292,229 entitled “Transparent Digitizer” both of which are assigned to N-trig Ltd., the contents of both which are incorporated herein by reference, describe a positioning device capable of locating multiple physical objects positioned on a Flat Panel Display (FPD) and a transparent digitizer sensor that can be incorporated into an electronic device, typically over an active display screen of the electronic device. The digitizer sensor includes a matrix of vertical and horizontal conductive lines to sense an electric signal. Typically, the matrix is formed from conductive lines patterned on two transparent foils that are superimposed on each other. Positioning the physical object at a specific location on the digitizer provokes a signal whose position of origin may be detected.

U.S. Pat. No. 7,372,455, entitled “Touch Detection for a Digitizer” assigned to N-Trig Ltd., the contents of which is incorporated herein by reference, describes a digitizing tablet system including a transparent digitizer sensor overlaid on a FPD. The transparent digitizing sensor includes a matrix of vertical and horizontal conductive lines to sense an electric signal. Touching the digitizer in a specific location provokes a signal whose position of origin may be detected. The digitizing tablet system is capable of detecting position of multiple physical objects and fingertip touches using same conductive lines.

U.S. Patent Application Publication No. US20070292983, entitled “Methods for manufacturing a sensor assembly” assigned to N-Trig Ltd., the contents of which is incorporated herein by reference, describes methods for mounting a substrate such as a Printed Circuit Board (PCB) on conductive pads provided on a sensor. For example a grid based digitizer sensor including conductive pads along its edges and formed with a PET foil or glass is described. Since substrates such as PET foil and glass are typically heat sensitive, traditional methods for establishing electrical and mechanical contact between two substrates such as soldering or using Anisotropic Conductive Paste (ACP) or Film (ACF) cannot be used. Instead, some embodiments describe using conductive adhesive to provide the contact between the conductive pads of a sensor and matching conductive pads on a PCB. In some embodiments, non-conductive spacers are described and used to block lateral flow of the conductive adhesive and avoid creating lateral conductance between neighboring conductive pads during mounting.

International Publication No. WO2009/057102, entitled “Laminated Digitizer Sensor” assigned to N-Trig Ltd., the contents of which is incorporated herein by reference, describes a laminated transparent digitizer sensor assembly including two transparent layers each patterned on one surface with an array of conductors and laminated with non conductive material so that the patterned surfaces face each other. In some exemplary embodiments, electrical contact from one layer is passed on the facing layer by depositing conductive material between the layers. Conductive material is also used to establish contact between a PCB mounted on the sensor and conductive lines and/or pads patterned on the sensor. In some exemplary embodiments, anisotropic conductive material is used to establish the connection along one direction perpendicular to the patterned substrate surfaces while avoiding shorting between contiguous conductive lines within the set.

### SUMMARY OF THE INVENTION

According to an aspect of some embodiments of the present invention there is provided a method for mounting a PCB or like substrate on a digitizer sensor so as to establish electrical connection between conductive lines patterned on the digitizer sensor and matching contact points patterned on the PCB while avoiding shorting between contiguous conductive lines and/or contiguous contact points. It is noted that a PCB or like structure includes flexible printed circuits, flexible printed cables and/or any substrate including circuitry, electrical and/or electronic components to be used with digitizer sensor, e.g. for operating the digitizer sensor.

An aspect of some embodiments of the present invention provides for a digitizer assembly including: a transparent sensor patterned with conductive elements within at least one layer; a PCB or the like patterned with conductive elements positioned along at least one edge of the transparent sensor, wherein the conductive elements at least partially match the conductive elements on the transparent sensor; a double sided adhesive positioned between the transparent sensor and the PCB operative to mount the PCB on to the transparent sensor.

Optionally, the double sided adhesive is formed from alternate strips of conductive and non-conductive double sided adhesive.

Optionally, the conductive double sided adhesive is operative to provide electrical contact between conductive elements on the transparent sensor and conductive elements on the PCB.

Optionally, the double sided adhesive includes a pattern of openings that at least partially correspond to the conductive elements on the transparent sensor and the PCB.

Optionally, the openings are filled with conductive material.

Optionally, the conductive material is conductive adhesive.

Optionally, the conductive material is operative to provide electrical contact between conductive elements on the transparent sensor and conductive elements on the PCB.

Optionally, the double sided adhesive is operative to prevent lateral flow of the conductive material out of the openings.

Optionally, the double sided adhesive is non-conductive.

Optionally, the openings are holes or gaps in the double sided adhesive.

Optionally, the shapes or sizes of the opening correspond to the shape or size of the conductive elements.

Optionally, the pattern of conductive elements on the transparent sensor and on the PCB or the like includes an array of conductive elements.

Optionally, the transparent sensor includes at least one array of conductive lines and the pattern of conductive elements is formed on at least one of the ends of the conductive lines.

Optionally, the pattern of conductive elements includes at least one array of conductive lines.

Optionally, the conductive lines are constructed from a transparent material.

Optionally, the transparent sensor is constructed from a temperature sensitive material.

Optionally, the transparent sensor is constructed from a pressure sensitive material.

Optionally, the transparent sensor is constructed from a glass substrate or a PET foil.

An aspect of some embodiments of the present invention provides for a method for mounting a PCB or like substrate onto a transparent sensor each having a pattern of conductive elements thereon wherein the two patterns at least partially correspond, the method comprising: mounting a double-sided adhesive comprising a pattern of openings on one of the PCB or transparent sensor each comprising a pattern of conductive elements such that the openings on the double sided adhesive at least partially expose at least a portion of the pattern of conductive elements, and mounting the other one of the PCB or transparent sensor on the double sided adhesive so that at least a portion of its pattern of conductive elements correspond to at least a portion of the pattern of openings on the double sided adhesive.

Optionally, the method comprises injecting a conductive material in at least one of the openings.

Optionally, the double sided adhesive is operative to prevent lateral flow of the conductive material out of the openings.

Optionally, the conductive material is a conductive adhesive.

Optionally, the double sided adhesive is non-conductive.

Optionally, the openings are holes or gaps in the double sided adhesive.

Optionally, the shapes or sizes of the opening correspond to the shape or size of the conductive elements.

Optionally, the transparent sensor includes at least one array of conductive lines and the pattern of conductive elements is formed on at least one end of the conductive lines.

Optionally, the pattern of conductive elements includes at least one array of conductive lines.

An aspect of some embodiments of the present invention provides for a method for mounting a PCB or like substrate onto a transparent sensor each having a pattern of conductive elements thereon wherein the two patterns at least partially correspond, the method comprising: mounting a double-sided adhesive comprising a pattern of conductive and non-conductive portions on one of the PCB or transparent sensor each comprising a pattern of conductive elements such that the conductive portions on the double sided adhesive at least partially correspond to at least a portion of the pattern of conductive elements, and mounting the other one of the PCB or transparent sensor on double sided adhesive so that at least a portion of its pattern of conductive elements correspond to at least a portion of the conductive portions of the double sided adhesive.

Optionally, the double sided adhesive is formed from alternate strips of conductive and non-conductive double sided adhesive.

Optionally, the non-conductive portions form a pattern of openings and the conductive portions cover the openings formed by the non-conductive portions.

Optionally, the openings are holes or gaps in the double sided adhesive.

Optionally, the shapes or sizes of the opening correspond to the shape or size of the conductive elements.

Optionally, the conductive portions on the double sided adhesive are operative to provide electrical contact between conductive elements on the transparent sensor and conductive elements on the PCB.

An aspect of some embodiments of the present invention provides for a double sided adhesive for mounting a PCB or the like onto a transparent sensor, the double sided adhesive comprising: a pattern of conductive and non-conductive portions of double sided adhesive, wherein at least a part of the conductive portions correspond to pattern of conductive elements on the transparent sensor and a matching pattern of conductive elements on the PCB.

Optionally, the non-conductive portions form openings and the conductive portions fill or cover the openings.

Optionally, the openings are holes, wells or gaps.

Optionally, the double sided adhesive is formed from alternate strips of conductive and non-conductive double sided adhesive.

Optionally, the conductive portions of the double sided adhesive are operative to provide electrical contact between conductive elements on the transparent sensor and conductive elements on the PCB.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is an exemplary simplified block diagram of a prior art grid based digitizer system;

FIG. 2 is an exemplary schematic diagram of a prior art grid based digitizer sensor patterned with conductive pads along ends of conductive lines of the grid;

FIGS. 3A and 3B are exemplary schematic diagrams of oppositely facing surfaces of a prior art ‘L’ shaped PCB for use with a prior art digitizer system;

FIGS. 4A, 4B, 4C and 4D are exemplary strips of non-conductive DSA formed with openings operative to bind a PCB or like substrate to a digitizer sensor in accordance with some embodiments of the present invention;

FIGS. 5A and 5B are exemplary schematic digitizer sensors assembled with non-conductive DSA over which a PCB is to be mounted in accordance with some embodiments of the present invention;

FIGS. 6A and 6B are exemplary schematic PCBs overlaid with non-conductive DSA in accordance with some embodiments of the present invention;

FIGS. 7A and 7B are exemplary schematic diagrams of non-conductive DSA overlaid on a substrate and filled in with conductive material in accordance with some embodiments of the present invention;

FIG. 8 is an exemplary flow chart describing a method for binding a PCB substrate or the like to a digitizer sensor in accordance with some embodiments of the present invention;

FIG. 9 is schematic illustrations of a PCB mounted on a sensor with non-conductive DSA prior to filling openings in the DSA with conductive material in accordance with some embodiments of the present invention;

FIGS. 10A, 10B, 10C, and 10D are schematic illustrations of DSA constructed from conductive and non-conductive portions in accordance with some embodiments of the present invention;

FIGS. 11A and 11B are schematic illustrations of the assembly of a PCB on a sensor using DSA constructed from non-conducting and conducting sections in accordance with some embodiments of the present invention; and

FIG. 12 is an exemplary flow chart describing a method for binding a PCB substrate or the like to a digitizer sensor using DSA constructed from non-conducting and conducting sections in accordance with some embodiments of the present invention.

### DESCRIPTION OF SPECIFIC EMBODIMENTS OF THE INVENTION

The present invention, in some embodiments thereof, relates to assembly of digitizer sensors and, more particularly, but not exclusively, to methods for establishing electrical connection between conductive material of the digitizer sensor and electrical components associated with the sensor.

An aspect of some embodiments of the present inventions provides for using non-conductive Double Sided Adhesive (DSA) formed with holes, gaps or openings to bind a PCB or like substrate to a digitizer sensor. The holes, gaps or opening are formed to correspond to discrete areas where electrical contact is required between the PCB and the digitizer sensor. According to some embodiments of the present invention, the holes, gaps or opening formed provide a volume within which conductive material can be deposited so that electrical contact can be established between the PCB and sensor in the discrete areas where electrical contact is required. Additionally, the non-conductive material defining the holes, gaps or opening provide a barrier preventing lateral flow of conductive material in areas where electrical contact is not desired.

According to some embodiments of the present invention, during assembly, the non-conductive DSA is aligned and positioned on either the digitizer sensor or the PCB so that areas that require electric contact with the other substrate are exposed by the holes. In some exemplary embodiments, conductive material is injected into the holes (or at least one hole) and the other substrate is aligned over the first substrate so that matching conductive areas on each substrate correspond to each other. Optionally, pressure, e.g. a low pressure, is applied to bind the two substrates. Typically, the pressure applied is operative to urge the substrates together. Optionally, the openings formed in the non-conductive DSA, extend to an edge of the adhesive so that conductive material may be deposited through the openings after PCB is mounted on the digitizer sensor, i.e., they are adhered using the non-conductive DSA.

Optionally, the conductive material is in a liquid or paste form and is injected into the volume defined by the opening by injection. According to some embodiments of the present invention, lateral flow of conductive material is limited by the non-conductive DSA surrounding each hole, opening and/or gap so that shorting of contiguous conductive elements may be avoided.

According to some embodiments of the present invention, the conductive material positioned within the openings is in the form of a non-adhesive conductive film, single-sided conductive adhesive and/or a conductive DSA. The conductive material is fitted within the opening, e.g. hole, provided by the non-conductive material and/or positioned over the hole. Optionally, strips or pieces of the conductive film and/or adhesive are positioned on opposite surfaces through which the hole is formed and contact between facing conductive strips or pieces is established by applying pressure on the opposing surfaces and urging the opposite facing strips together. Optionally, the DSA is pressure sensitive adhesive.

According to some exemplary embodiments, there is provided a DSA including conducting and non-conducting areas that match a conductive pattern on a digitizer sensor and/or a PCB operative to be mounted on the digitizer sensor. In some exemplary embodiments, during assembly, the DSA including conducting and non-conducting areas is aligned on one of the digitizer sensor or PCB and the other surface is urged over the DSA. Optionally, the non-conducting adhesive is positioned on one of the digitizer sensor and/or PCB and the conducting adhesive is positioned over the other of the digitizer sensor and/or PCB and binding of the PCB and sensor is provided by urging the conductive and non-conductive DSA together. The present inventors have found that the assembly methods described herein are suitable for binding pressure sensitive and/or temperature sensitive substrates.

According to some embodiments of the present invention, the digitizer sensor is a transparent digitizer applicable for a mobile computing device that uses a Flat Panel Display (FPD) screen. The mobile computing device can be any device that enables interactions between the user and the device. Examples of such devices are Tablet PCs, pen enabled lap-top computers, Touchscreen, PDAs or any hand held devices such as palm pilots and mobile telephones.

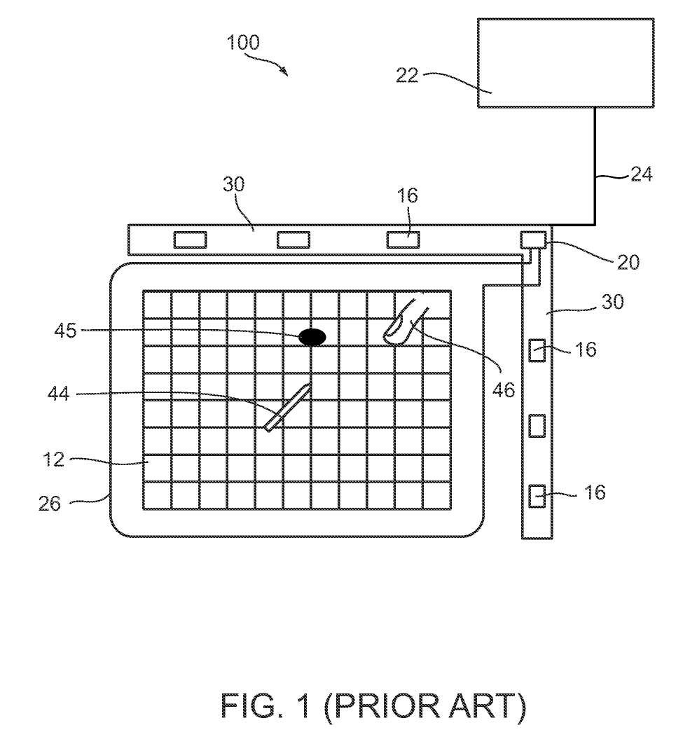

Referring now to the drawings, FIG. 1 illustrating an exemplary simplified block diagram of a prior art grid based digitizer system. Typically, the digitizer system 100 comprises a sensor 12 including a patterned arrangement of conductive lines, which is optionally transparent, and which is typically overlaid on a FPD. The conductive lines and the substrate are optionally transparent or are thin enough so that they do not substantially interfere with viewing an electronic display behind the lines.

Optionally, digitizer sensor 12 is a grid based sensor including horizontal and vertical conductive lines. Optionally, the conductive lines are structured from ITO and patterned on one or more glass substrates, foils and/or other substrates. Optionally, the grid is made of two layers, which are electrically insulated from each other. Optionally, one of the layers contains a first set of equally spaced parallel conductive lines and the other layer contains a second set of equally spaced parallel conductive lines orthogonal to the first set. Optionally, a protective layer is added to protect an exposed surface patterned with the conductive lines.

Typically, the parallel conductive lines are spaced at a distance of approximately 2-8 mm, e.g. 4 mm, depending on the size of the FPD and a desired resolution. Optionally the region between the grid lines is filled with a non-conducting material having optical characteristics similar to that of the (transparent) conductive lines, to mask the presence of the conductive lines.

In some known embodiments, circuitry is provided on one (or more) PCB(s) 30 mounted on sensor 12, e.g. along a frame of sensor 12. Optionally, PCB 30 is an ‘L’ shaped PCB and is mounted along two edges of sensor 12. Mounting PCB 30 directly on sensor 12 as opposed to connecting the PCB to the sensor with a set of connection lines provides for limiting the distance between conductive lines on sensor 12 and processing circuitry on the PCB and thereby limiting the interference that may be accumulated along a distance of connecting lines.

Typically, one or more ASICs positioned on PCB(s) 30 comprise circuitry to sample and process the sensor's output into a digital representation. Typically, ASICs 16 are connected to outputs of the various conductive lines in the grid and function to process the received signals at a first processing stage. Optionally, the ends of the lines remote from ASICs 16 are not connected so that the lines do not form loops. Typically, the digital output signal is forwarded to a digital ASIC unit 20 also on PCB 30, for further digital processing. Output from the digitizer sensor is forwarded to a host 22 via an interface 24 for processing by the operating system or any current application. Typically, digital unit 20 determines position and/or tracking information of physical objects, such as stylus 44, conductive object 45 and/or finger 46 over time and sends such information to the host computer via interface 24.

According to some known embodiments, digital unit 20 together with ASICs 16 produce and send a triggering pulse to at least one of the conductive lines. Typically the triggering pulses and/or signals are analog pulses and/or signals, e.g. AC pulses or signals. Optionally, finger touch detection is facilitated when sending a triggering pulse to the conductive lines.

In some known embodiments, digital unit 20 additionally produces and controls a triggering pulse provided to an excitation coil 26 that surrounds the sensor arrangement and the display screen. The excitation coil provides a trigger pulse that excites passive circuitry in stylus 44. In some exemplary embodiments, an excitation coil is not included.

Typically, an electronic display associated with the host computer displays images. Optionally, the images are displayed on a display screen situated below a surface on which the object is placed and below the sensors that sense the physical objects or fingers. Optionally, the surface functions as a game board and the object is a gaming piece, or a toy. Typically, digitizer sensor operates as a user input device to host 22.

Several touch detection methods using a digitizer system similar to digitizer system 100 or other digitizer systems is described for example in incorporated U.S. Pat. No. 7,372,455. However, it is noted that the present invention is not limited to a specific type of touch and/or object detection and/or to a specific digitizer system. It is also noted that the present invention is not limited to the technical description of the digitizer system described herein. The present invention may also be applicable to other digitized sensor and touch screens known in the art, depending on their construction.

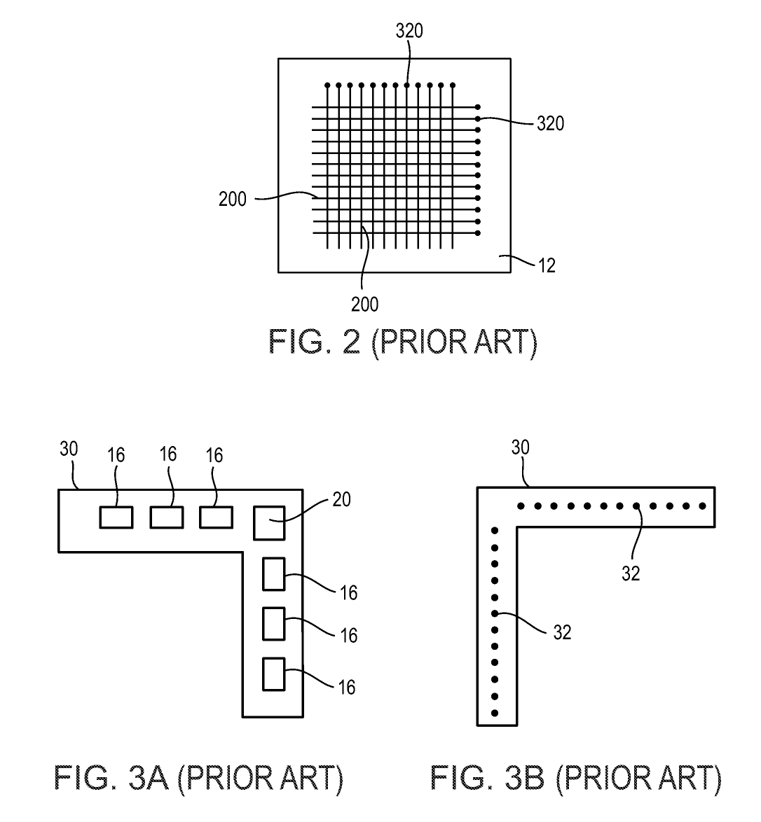

FIG. 2 is an exemplary schematic diagram of a prior art grid based digitizer sensor patterned with conductive pads along ends of conductive lines of the grid. Optionally, each conductive line 200 is connected to, or formed with one of a plurality of conductive elements, such as electric pads 320, at or near the edge of the foils. Optionally, electric pads 320 are made of graphitic or silver material. Typically, each conductive line is connected to one of a plurality of electrical conductive pads 320 at or near the edge of the transparent layer and is operative to provide for a contact area for electrical connection with a substrate mounted over elements 320. Optionally, the electric pads 320 are made of graphitic or silver material or any other conductive material, such as: ITO. Optionally, electric pads 320 are provided on both ends of conductive lines 200 and the electric pads on one or two of the ends are used for testing the lines. In some exemplary embodiments, electrical connection with a substrate mounted over the sensor is provided by direct contact with edges of conductive lines 200 and the conductive elements are conductive lines 200, e.g. the ends of the conductive lines. In such as case, electric pads 320 are not used.

FIGS. 3A and 3B show exemplary schematic diagrams of oppositely facing surfaces of a prior art ‘L’ shaped PCB for use with a prior art digitizer system. Optionally, PCB 30 includes a set of conductive elements or pads 32 over one surface of the PCB that matches or corresponds to conductive elements 320 on sensor 12 so that PCB can be mounted on sensor 12 and establishes contact with each conductive line 320 of the sensor. In some known systems, conductive elements 32 are positioned on a surface of a PCB or like structure opposite a surface over which electrical components, e.g. ASICs 16 is positioned. Typically, each conductive element 32 on PCB 30 is required to make electrical contact with a corresponding conductive element 320 on the sensor while avoiding lateral electrical conduction with contiguous electrical elements 32 and/or 320. Optionally, conductive elements 32 are made of nickel coated with gold or other conductive material, such as: cooper, Pb/Sn, or silver. Optionally, conductive elements 32 are not of uniform size and shape.

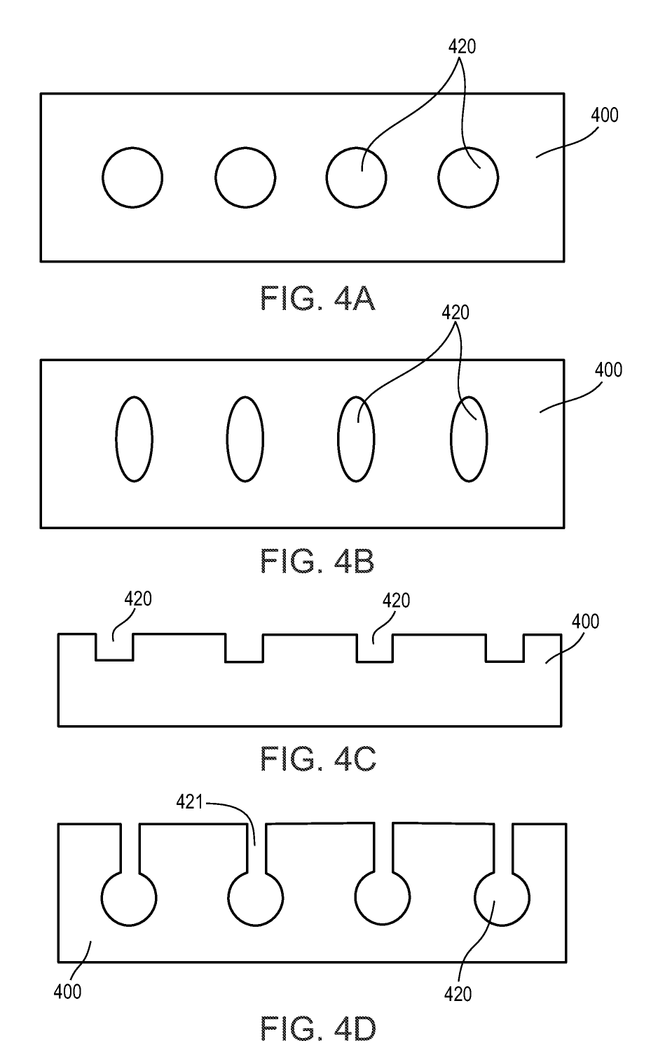

Reference is now made to FIGS. 4A, 4B, 4C and 4D showing exemplary strips of non-conductive DSA formed with openings operative to bind and electrically connect by physical connection a PCB or like substrate to a digitizer sensor or other sensor in accordance with some embodiments of the present invention. According to some embodiments of the present invention, a DSA 400 formed with a non-conductive material is used to fixedly mount a PCB 30 or like substrate to a digitizer sensor or other touch sensitive sensor. According to some embodiments of the present invention, the DSA is formed with a pattern of openings 420 that provide for exposing areas where electrical contact between the PCB and sensor are required while isolating areas where electrical contact between the PCB and sensor is not desired. Typically, openings 420 correspond to positions of conductive elements 320 on a sensor 12 and/or conductive elements 32 on a PCB 30.

In some exemplary embodiments, the openings 420 are formed with a circular shape (FIG. 4A) or an oval shape (FIG. 4B). Optionally, the holes may have other shape, e.g. square shape or rectangular shape. According to some embodiments of the present invention, openings 420 extend to an edge of a DSA strip 400 and form wells (FIG. 4C). In some exemplary embodiments, the openings 420 include a channel 421 operative to receive the conductive material within a wider portion of openings 420 and prevent or reduce leakage out of the openings 420 (FIG. 4D). It is noted that openings 420 may include holes, channels, or gaps in DSA 400.

Typically, the shape of openings 420 correspond to the shape of the conductive elements 32 on the PCB and/or conductive elements 320 on sensor 12 so that wide overlap and stable contact may be formed between matching conductive elements of the sensor and PCB while reducing exposed areas where contact is not desired. Optionally, the holes have similar size as conductive elements on matching PCBs and/or sensors. Optionally, openings 420 have an area that larger or smaller than conductive elements on matching PCBs and/or sensors.

In some exemplary embodiments, circular shaped holes are provided for square shaped conductive elements while oval shaped openings are used for rectangular shape conductive elements. Optionally, the diameter of the circular shape hole is approximately several millimeters, e.g. 1.5-2 mm. Typically, the distance between holes corresponds to the distance between the conductive pads, e.g. 4 mm corresponding to a distance between conductive lines 200 of sensor 12.

In some exemplary embodiments, DSA 400 is formed from a Pressure Sensitive Adhesive (“PSA”). Typically, the DSA is provided in a single strip unit and two strips of the DSA are used to assemble an ‘L’ shaped PCB 30 to sensor 12. In some exemplary embodiments, the DSA is provided as a roll, and each strip is cut from the roll, according to the size required. Optionally, an ‘L’-shape DSA is used. Optionally, the DSA is made of several strip units.

The DSA may be constructed from a variety of materials coated with adhesive on two sides. A pressure sensitive DSA may be constructed for example from acrylic or rubber and coated onto a backing material such as poly-propylene, PET, PolyEthylene (PE). PSA provides a sticky, e.g. tacky surface that facilitates adhering with light pressure and without requiring application of heat or solvent for activation.

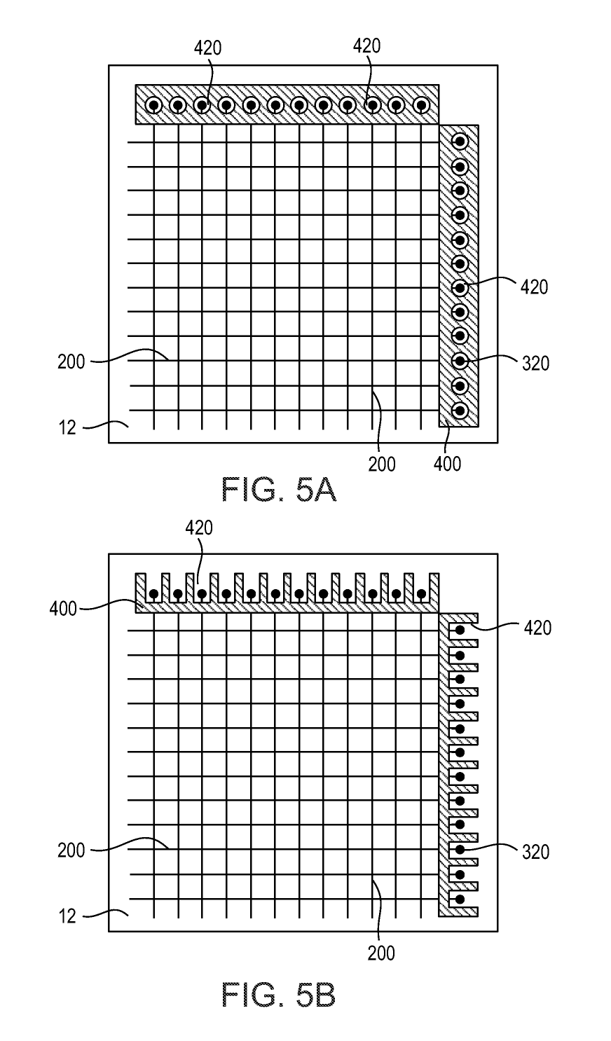

Reference is now made to FIGS. 5A and 5B showing exemplary schematic digitizer sensors assembled with non-conductive DSA over which a PCB is to be mounted in accordance with some embodiments of the present invention. According to some embodiments of the present invention, DSA 400 is constructed to match a pattern of conductive elements 320 on a sensor. During assembly the DSA is positioned on a substrate, e.g. PCB 30 or sensor 12, and aligned so that at least a portion of conductive elements 320 are exposed while an area between contiguous conductive elements is covered, e.g. protected with adhesive 400 that is formed from non-conductive material. Optionally openings 420 extend to an edge of the DSA 400 and are optionally aligned with an edge of the substrate, e.g. sensor 12, over which it is mounted. Optionally DSA is ‘L’-shaped and corresponds to the dimensions of PCB 30.

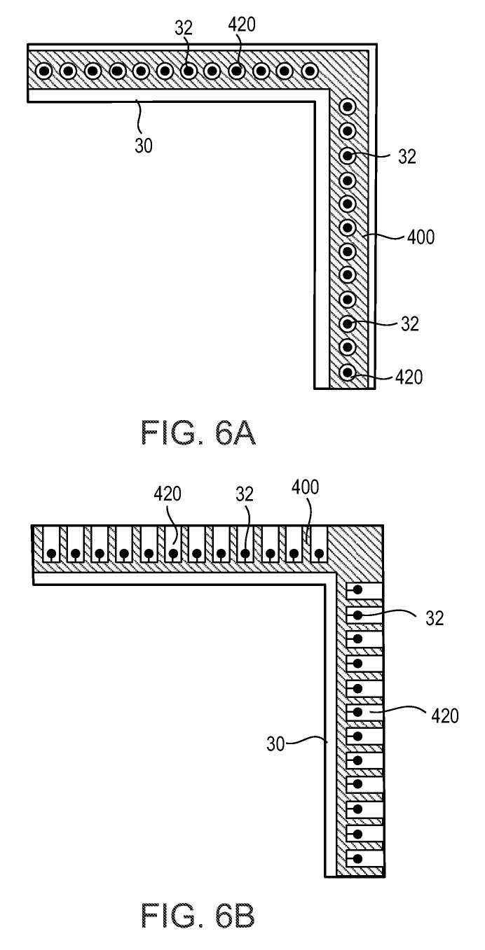

Alternatively as shown in FIGS. 6A and 6B, during assembly the DSA is mounted directly on the PCB and aligned so that at least a portion of conductive elements 32 are exposed while an area between contiguous conductive elements is covered, e.g. protected with adhesive 400 that is formed from non-conductive material. Optionally openings 420 extend to an edge of the DSA 400 and are aligned with an edge of the substrate, e.g. PCB 30, over which it is mounted.

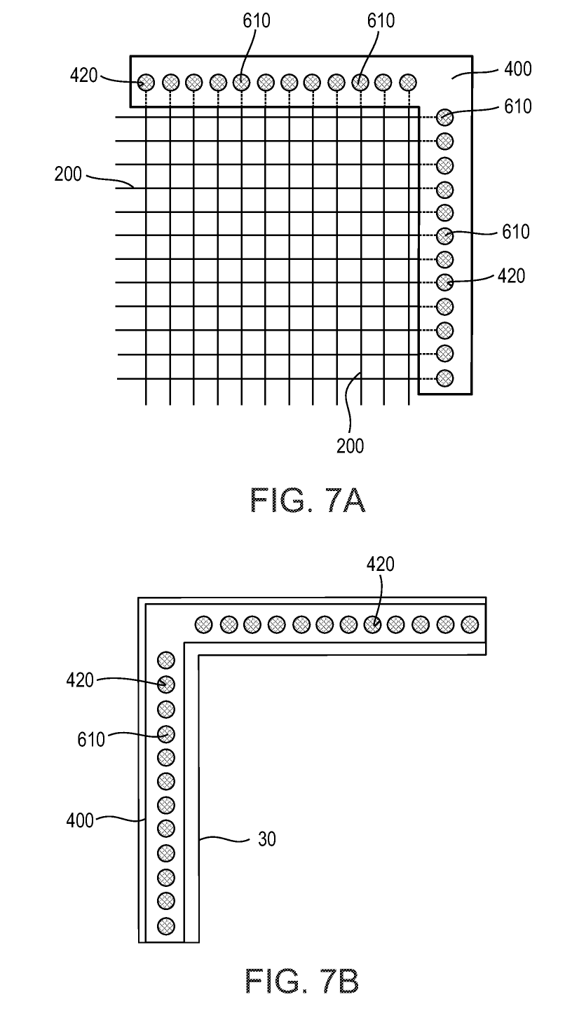

Referring now to FIGS. 7A and 7B showing schematic diagrams of non-conductive DSA overlaid on a substrate and filled in with conductive material in accordance with some embodiments of the present invention. According to some embodiments of the present invention, areas defined by the openings of the adhesive is filled in with conductive material 610 to facilitate conductance between conductive elements of the bound substrates, e.g. PCB 30 and sensor 12. According to some embodiments of the present invention, the thickness of the DSA is approximately 0.1 mm-0.3 mm. Typically, the thickness of the DSA 400 defines a volume within openings 420 where conductive material 610 may be deposited and retained within the defined area of the opening. Typically, the conductive material is in the form of an adhesive. Optionally, the material used for the conductive adhesive is epoxy filled with silver or nickel or gold or any other conductive materials. Optionally, conductive silicone is used as the conductive adhesive. Optionally, other conductive adhesive is used. In some exemplary embodiments, the conductive material is injected using a dispenser. Optionally, the dispensing is performed manually. Optionally, the dispensing is performed automatically, e.g. by a robot. In some exemplary embodiments, the conductive material is introduced and/or dispensed from direction generally perpendicular to an adhesive surface of the DSA. Optionally, the conductive material is dispensed and/or introduced from the side, e.g. in a direction generally parallel to an adhesive surface of the DSA.

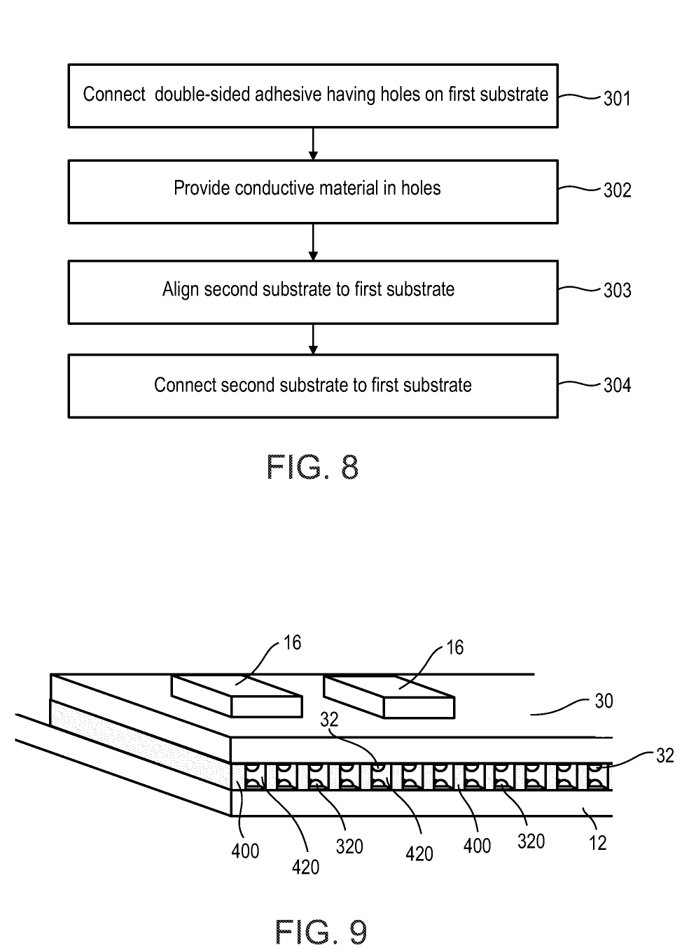

Reference is now made to FIG. 8 describing a method for binding a PCB substrate or the like to a digitizer sensor in accordance with some embodiments of the present invention. According to some embodiments of the present invention, a non-conductive DSA including openings that match conductive elements on a substrate is connected on a first substrate, e.g. sensor 12 or PCB 30 and aligned so that the conductive elements on the substrate are exposed (at least partially exposed) by openings on the DSA (block 301). Optionally, conductive material is deposited into one or more of the openings to provide for electrical contact between the two substrates at defined points or areas (block 302). According to some embodiments of the present invention, the second substrate, e.g. sensor 12 or PCB 30, is aligned over the first substrate so that conductive elements on the second substrate match up with the conductive elements exposed on the first substrate (block 303). Contact is established between the second substrate and DSA so that the second substrate is fixedly attached to the first substrate (block 304). By connecting two substrates with DSA, the substrates can be assembled without heating the substrates and/or applying an amount of pressure that can lead to damaging of a pressure sensitive substrate. Additionally, the DSA formed with defined openings provide for containing and/or confining conductance between the two substrates to defined areas where conductance is required and isolating areas where conductance is not required.

Alternatively, according to some embodiments of the present invention, when the openings in the DSA extend to edge of the adhesive (FIG. 4C, FIG. 5B and FIG. 6B), the conductive material can be introduced from a side of the sensor assembly, e.g. in a direction generally parallel to the sensor, into the openings after bounding the first and second substrate with the DSA. FIG. 9 shows a PCB mounted on a sensor with non-conductive DSA prior to filling openings in the DSA with conductive material in accordance with some embodiments of the present invention. Once PCB 30 is fixedly mounted on sensor 12 with DSA 400, openings 420 define dedicated chambers with adhesive 400 serving as the walls of the chamber and sensor 12 and PCB 30 serving as a floor a ceiling for the chamber. Conductive material may be injected into the openings of each chamber to provide for electrical contact between matching conductive elements 32 and 320 while avoiding lateral flow of the conductive material to contiguous chambers. Optionally, the conductive material is injected at the furthest point from the openings in order to avoid flow of the conductive material out of the openings. In some exemplary embodiments, a glass layer positioned over the sensor but exposing ends of the conductive lines and/or exposing the conductive pads is operative to prevent conductive material flow out of the openings 420, e.g. gaps.

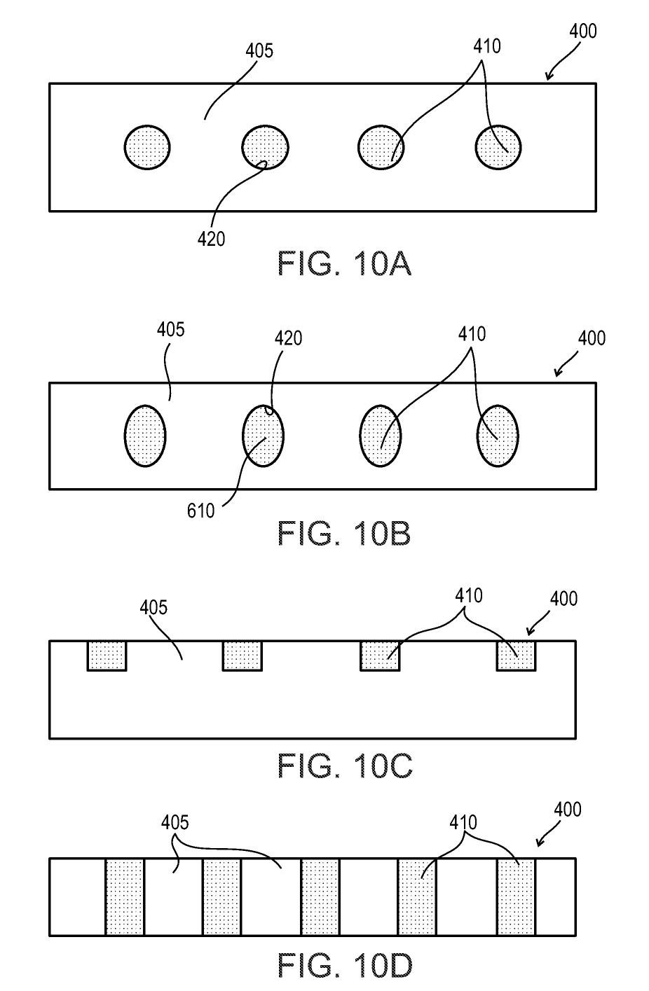

Reference is now made to FIGS. 10A, 10B, 10C, and 10D showing schematic illustrations of double sided adhesive constructed from conductive and non-conductive portions in accordance with some embodiments of the present invention. According to some embodiments of the present invention, DSA 400 is constructed with non-conductive parts 405 and conductive parts 410. In some exemplary embodiments, conductive parts 410 are fitted into opening 420 provided in DSA 400 and conductive parts 410 may be of various shapes, e.g. circular, oval, square, and rectangular. In some exemplary embodiments, the conductive parts 410 have a different shape and/or size than openings 420. Optionally, the conductive parts are positioned on both sides (opposite surfaces) of the non-conductive adhesive 405. Optionally, conductive parts 410 are a DSA. According to some embodiments of the present invention, the conductive parts 410 are assembled within or on openings 420 prior to positioning DSA 400 on one of the two substrates to be bound.

According to some embodiments of the present invention, the DSA is constructed from strips of conductive DSA material 410 and non-conductive DSA material 405 (FIG. 10D). Optionally, only the non-conductive material 405 is a DSA and the conductive material is not an adhesive material or is only adhesive on one surface. In some exemplary embodiments, the non-conductive and conductive strips are interleaved.

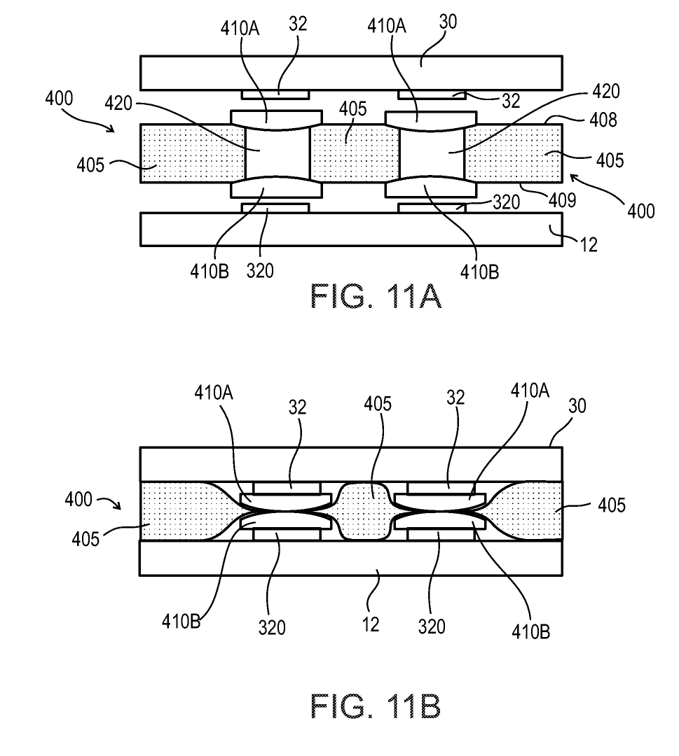

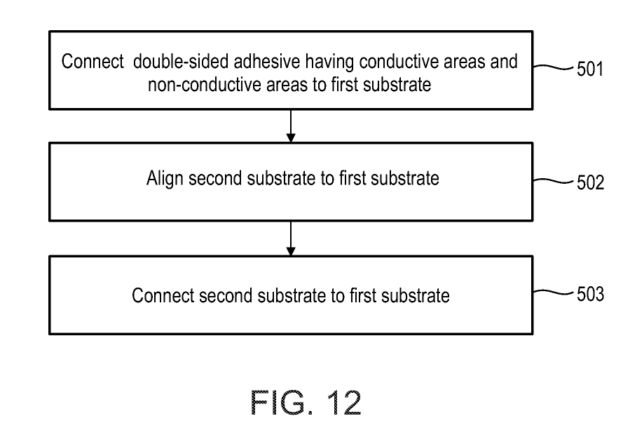

FIGS. 11A and 11B are schematic illustrations of a side view of the assembly of a PCB on a sensor using DSA constructed from non-conducting and conducting sections in accordance with some embodiments of the present invention. The DSA 400 may be one of the DSAs shown in FIGS. 10A-10C. According to some embodiments of the present invention, conductive material 410 is positioned or layered on both sides of non-conductive DSA 400, e.g. surface 408 and 409. The first layer of conductive material 410A provide for establishing electrical contact with PCB 30 and the second layer of conductive material 410B provide for establishing electrical contact with sensor 12. Typically, conductive material 410 is a DSA. Optionally, conductive material 410 has a form that protrudes into a gap or opening 420 in between or in non-conductive material 405 as in FIG. 10D or as in FIGS. 10A-C respectively. Typically, conductive material 410 is a thinner layer than the non-conductive material 405. Optionally, the thickness of layers 410A and 410B together are substantially the same as the thickness of non-conductive material 405. Alternatively, the conductive and non-conductive layers have the same thickness.

According to some embodiments of the present invention, during assembly PCB 30 and sensor 12 are urged as shown in FIG. 11B to bind sensor 12 to PCB 30 with non conductive adhesive 405 between contiguous conductive elements 32 and contiguous conductive elements 320 and establish electrical contact between matching conductive elements 32 and 320 and avoid electrical contact between PCB 30 and sensor 12 in other areas.

Typically, the DSA is a thin layer so that the PCB substrate when assembled appears to be mounted directly on the surface of the sensor array. However, in some exemplary embodiments, a thicker layer of DSA is used and the PCB substrate can then be positioned substantially above or below the sensor array plane.

Reference is now made to FIG. 13 describing a method for binding a PCB substrate or the like to a digitizer sensor using double sided adhesive constructed from non-conducting and conducting sections in accordance with some embodiments of the present invention. According to some embodiments of the present invention, a DSA patterned with conductive and non-conductive sections is aligned and positioned over a first substrate including an array of conductive elements (block 501). A second substrate, typically including a second array of conductive elements matching those of the first array is aligned over the DSA (block 502). The first and second substrates are urged together and thereby fixedly bound or assembled (block 503).

According to some embodiments of the present invention, the digitizer system comprises a peripheral coil operated by component on a PCB 30 mounted on sensor 12. Optionally, a ‘self-supported coil’, i.e. a coil that doesn't require winding around a core, is used. In some exemplary embodiments, the ‘self-supported coil’ is provided as a sub-assembly unit and is mounted along the edges of sensor 12, e.g. around sensor 12. In some exemplary embodiments of the invention, the DSA is further used to connect the peripheral coil to the sensor. In some exemplary embodiments, the DSA extends beyond the PCB to enable adhering the coil to sensor 12 beyond the PCB, e.g. between the PCB and edges of sensor 12. Optionally, a separate DSA, e.g. a non conductive DSA that is not formed with holes or conductive parts is provided on the sensor array edges not connected to the PCB to support the coil on sensor 12.

In some exemplary embodiments of the present invention, non-conducting material 405 and/or conductive material 410 are not adhesive material. Optionally, non-conducting material 405 is a film or layer including holes, openings or gaps that provides for isolating portions of an interface between sensor 12 and PCB 30 while providing electrical contact in designated areas of interface between sensor 12 and PCB 30, e.g. corresponding to electrical contact points between PCB 30 and sensor 12. In some exemplary embodiments, during assembly, a layer of non-conductive material that is not adhesive is positioned between PCB 30 and sensor 12. Optionally, conductive material, e.g. conductive adhesive, is introduced within the holes and openings formed by the non-conductive material. In some exemplary embodiments, the PCB and sensor are subsequently fixedly attached by clips or clamps or screws. Optionally, the PCB and sensor are fixedly attached with strips of DSA positioned on two ends of the PCB as opposed to substantially the entire interface of the PCB with the sensor.

It should be noted that although the above methods are described in the context of securing a PCB to a sensor array, these methods can be utilized in order to create electric contact between different components, modules and substrate materials.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

What is claimed is:

1. A digitizer assembly including:
a transparent sensor patterned with conductive elements within at least one layer;
a PCB or the like patterned with conductive elements positioned along at least one edge of the transparent sensor, wherein the conductive elements at least partially match the conductive elements on the transparent sensor; and
a double sided adhesive positioned between the transparent sensor and the PCB operative to mount the PCB on to the transparent sensor.

2. The assembly according to claim 1, wherein the double sided adhesive is formed from alternate strips of conductive and non-conductive double sided adhesive.

3. The assembly according to claim 2, wherein the conductive double sided adhesive is operative to provide electrical contact between conductive elements on the transparent sensor and conductive elements on the PCB.

4. The assembly according to claim 1, wherein the double sided adhesive includes a pattern of openings that at least partially correspond to the conductive elements on the transparent sensor and the PCB.

5. The assembly according to claim 4 wherein the openings are filled with conductive material.

6. The assembly according to claim 5, wherein the conductive material is conductive adhesive.

7. The assembly according to claim 5, wherein the conductive material is operative to provide electrical contact between conductive elements on the transparent sensor and conductive elements on the PCB.

8. The assembly according to claim 5, wherein the double sided adhesive is operative to prevent lateral flow of the conductive material out of the openings.

9. The assembly according to claim 4, wherein the double sided adhesive is non-conductive.

10. The assembly according to claim 4, wherein the openings are holes or gaps in the double sided adhesive.

11. The assembly according to claim 4, wherein the shapes or sizes of the opening correspond to the shape or size of the conductive elements.

12. The assembly according to claim 1 wherein the pattern of conductive elements on the transparent sensor and on the PCB or the like include an array of conductive elements.

13. The assembly according to claim 1, wherein the transparent sensor includes at least one array of conductive lines and the pattern of conductive elements is formed on at least one of the ends of the conductive lines.

14. The assembly according to claim 1, wherein the pattern conductive elements includes at least one array of conductive lines.

15. The assembly according to claim 13, wherein the conductive lines are constructed from a transparent material.

16. The assembly according to claim 1, wherein the transparent sensor is constructed from a temperature sensitive material.

17. The assembly according to claim 1, wherein the transparent sensor is constructed from a pressure sensitive material.

18. The assembly according to claim 1, wherein the transparent sensor is constructed from a glass substrate or a PET foil.

19. A method for mounting a PCB or like substrate onto a transparent sensor each having a pattern of conductive elements thereon wherein the two patterns at least partially correspond, the method comprising:
mounting a double-sided adhesive comprising a pattern of openings on one of the PCB or transparent sensor each comprising a pattern of conductive elements such that the openings on the double sided adhesive at least partially expose at least a portion of the pattern of conductive elements, and
mounting the other one of the PCB or transparent sensor on the double sided adhesive so that at least a portion of its pattern of conductive elements correspond to at least a portion of the pattern of openings on the double sided adhesive.

20. The method according to claim 19, comprising injecting a conductive material in at least one of the openings.

21. The method according to claim 20, wherein the double sided adhesive is operative to prevent lateral flow of the conductive material out of the openings.

22. The method according to claim 20, wherein the conductive material is a conductive adhesive.

23. The method according to claim 19, wherein the double sided adhesive is non-conductive.

24. The method according to claim 19, wherein the openings are holes or gaps in the double sided adhesive.

25. The method according to claim 19, wherein the shapes or sizes of the opening correspond to the shape or size of the conductive elements.

26. The method according to claim 19, wherein the transparent sensor includes at least one array of conductive lines and the pattern of conductive elements is formed on at least one end of the conductive lines.

27. The method according to claim 19, wherein the pattern of conductive elements includes at least one array of conductive lines.

28. A method for mounting a PCB or like substrate onto a transparent sensor each having a pattern of conductive elements thereon wherein the two patterns at least partially correspond, the method comprising:
mounting a double-sided adhesive comprising a pattern of conductive and non-conductive portions on one of the PCB or transparent sensor each comprising a pattern of conductive elements such that the conductive portions on the double sided adhesive at least partially correspond to at least a portion of the pattern of conductive elements, and
mounting the other one of the PCB or transparent sensor on double sided adhesive so that at least a portion of its pattern of conductive elements correspond to at least a portion of the conductive portions of the double sided adhesive.

29. The method according to claim 28, wherein the double sided adhesive is formed from alternate strips of conductive and non-conductive double sided adhesive.

30. The method according to claim 28, wherein the non-conductive portions form a pattern of openings and the conductive portions cover the openings formed by the non-conductive portions.

31. The method according to claim 30, wherein the openings are holes or gaps in the double sided adhesive.

32. The method according to claim 30, wherein the shapes or sizes of the opening correspond to the shape or size of the conductive elements.

33. The method according to claim 28, wherein the conductive portions on the double sided adhesive is operative to provide electrical contact between conductive elements on the transparent sensor and conductive elements on the PCB.

34. A double sided adhesive for mounting a PCB or the like onto a transparent sensor, the double sided adhesive comprising:
a pattern of conductive and non-conductive portions of double sided adhesive,
wherein at least a part of the conductive portions correspond to pattern of conductive elements on the transparent sensor and a matching pattern of conductive elements on the PCB.

35. The double sided adhesive according to claim 34, wherein the non-conductive portions form openings and the conductive portions fill or cover the openings.

36. The double sided adhesive according to claim 35, wherein the openings are holes, wells or gaps.

37. The double sided adhesive according to claim 34, wherein the double sided adhesive is formed from alternate strips of conductive and non-conductive double sided adhesive.

38. The double sided adhesive according to claim 34, wherein the conductive portions of the double sided adhesive are operative to provide electrical contact between conductive elements on the transparent sensor and conductive elements on the PCB.
